(19) United States
(12) Patent Application Publication
(10) Pub. No.: US 2009/0053674 A1
(43) Pub. Date: Feb. 26, 2009

(54) DENTAL DRILL

(75) Inventor: Karl-Heinz Danger, Detmold (DE)

Correspondence Address: PEARNE & GORDON LLP, 1801 EAST 9TH STREET, SUITE 1200, CLEVELAND, OH, 44114-3108, US

(73) Assignee: GEBR. BRASSELER GMBH & CO. KG, Lemgo (DE)

(21) Appl. No.: 11/843,365

(22) Filed: Aug. 22, 2007

(51) Int. Cl. A61C 5/02

(52) U.S. Cl. 433/102

(57) ABSTRACT

The invention relates to a dental drill comprising a shaft as well as a head being provided with a plurality of cutting edges extending lengthwise of the head, wherein the cutting edges are provided with at least one cross-cut at a middle portion of the head.

### FIELD OF THE INVENTION

The present invention relates to a dental drill having a shaft, the distal free end of which is provided with a head provided comprising cutting edges.

### BACKGROUND OF THE INVENTION

From the state of the art, it is known to manufacture dental drills with different designs. The shape as well as the type of the cutting edges (toothing) are adapted to the respective purposes of application, such that the dentist may select the optimum tool for each preparation step.

The design of the cutting edges may be straight-lined. However, it is also known to provide the complete cutting edges of the head with one or more cross-cuts. These cross-cuts, having the shape of peripheral grooves or helical grooves, divide the cutting edges into individual cutting portions. Therewith, small chips are produced. Furthermore, the cutting efficiency of the dental drill is increased.

Such cutting edges being provided with cross-cuts, however, result in an inferior surface quality, such that these dental drills may only be used in a first processing step for a rough pre-processing. In order to obtain a smooth surface with high quality, it is required to use a dental drill being provided with continuous cutting edges not being interrupted by a cross-cut.

It has thus to be noted that the dentist has to use a plurality of dental drills or dental instruments in order to perform the preparation work. This results in increased costs for the different dental drills and requires a considerable expenditure of time for exchanging the dental drills during the preparation treatment.

It is therefore an object of the invention to create a dental drill which enables a high-quality preparation in a preferably short period of time.

### ABSTRACT OF THE INVENTION

According to the invention, a dental drill is provided, the head of which is divided into three different portions. Therein, the portion of the head facing the shaft as well as the portion facing the free distal end are provided with cutting edges which are not interrupted by a cross-cut, whereas the cutting edges of a middle portion of the head are divided by at least one cross-cut.

According to the invention, the cross-cut is formed in the shape of a groove interrupting the cutting edge and therewith the cutting flange. Therefrom, there results an increased cutting efficiency. The chips of the removed material are divided into small chips.

The smooth cutting edges of the distal end portion of the head as well as the of the end portion of the head facing the shaft enable a high-quality preparation with very good surfaces.

The inventive dental drill may therefore be used to achieve a high cutting performance, but is also capable to prepare smooth edges, e. g. for the inlay preparation of for the classic cavity preparation in the area of the cavity rim.

The dentist therewith can perform different processing steps with different qualities by using one single dental drill, without the necessity to exchange the tool. Therefrom, there results a considerable time saving.

The quality of the surface to be processed is also enhanced by the respective end portions of the head which has no cross-cuts in that only a minimum vibration of the dental drill occurs during operation.

The inventive dental drill comprises several cutting edges distributed equally or non-equally about its periphery, the cutting edges being substantially straight-lined, wherein the cutting edges may also be provided with a twist. According to the invention, a left-handed twist as well as a right-handed drill is provided. Preferably, the dental drill is right-hand cutting with respect to its rotation about its longitudinal axis.

The shapes of the head may be adapted easily to the respective requirements. The head may thus be shaped conical, tapered, spherical, pear-shaped or in the shape of a conical cylinder.

Concerning the complete axial length of the head, it is preferred that the front and rear portions being not provided with a cross-cut respectively cover 5 to 20% of the complete length.

In order to increase the strength and service life of the inventive dental drill, a method of manufacturing is proposed in which at first the shaft as well as the blank shape of the head are lathed and/or ground from a hard metal blank. Subsequently, the cutting edges of the head are produced by means of a grinding step. In a further processing step, a helical groove is ground into the middle portion of the head by means of preferably one grinding wheel, said groove serving to divide the individual cutting edges into cutting portions which have substantially the same length. Therewith, the cross-cut provided according to the invention is created. Said cross-cut therewith only forms an interruption of the cutting edges, but does not create any additional further toothing, as it is provided in dental instruments having a staggered tooth system in which the tooth system itself forms cutting portions. In case of the inventive dental drill, only the cutting portions are self-cutting, the cross-cut interrupts the cutting edges or cutting flanges.

### SHORT DESCRIPTION OF THE DRAWINGS

FIG. 1 shows a perspective view of a head according to a first preferred embodiment of the invention,

FIGS. 2 and 3 show further alternative head shapes of preferred embodiments of the invention,

FIG. 4 shows a perspective view of a preferred embodiment according to the head shape in FIG. 1,

FIG. 5 to 13 respectively show detailed lateral views of further preferred embodiments with related front views of the respective head as well as detailed depictions of the cutting edges.

### DETAILED DESCRIPTION OF CURRENTLY PREFERRED EMBODIMENT

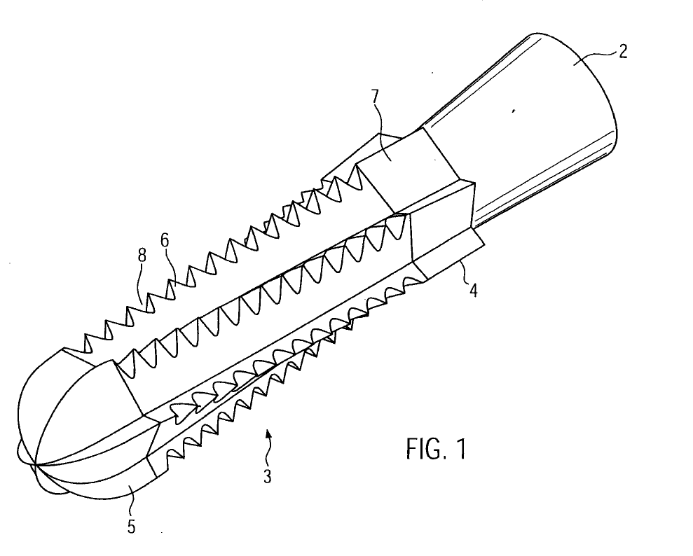

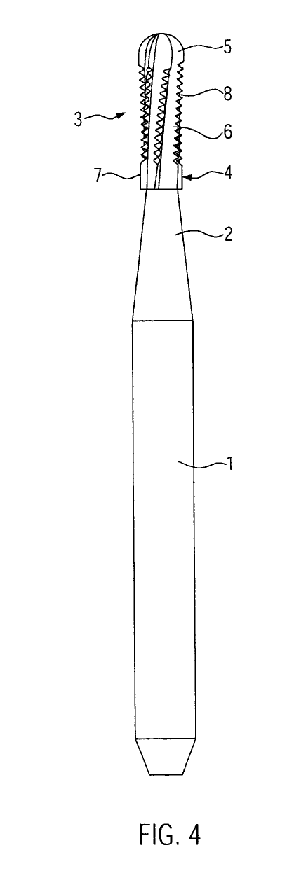

FIGS. 1 and 4 show a first preferred embodiment of an inventive dental drill comprising a cylindrical shaft 1 which is provides with clamping means (not shown) in order to be insertable into a driving tool and coupled therewith. The shaft comprises a tapering shaft end 2 which is integrally provided with a head 3. The head 3 is substantially shaped cylindrical and provided with cutting edges 4 which are formed substantially straight-lined and have a twist.

The head 3 is divided into three portions, i. e. a distal end portion 5, a middle portion 6 as well as an end portion 7 adjacent to the shaft end 2.

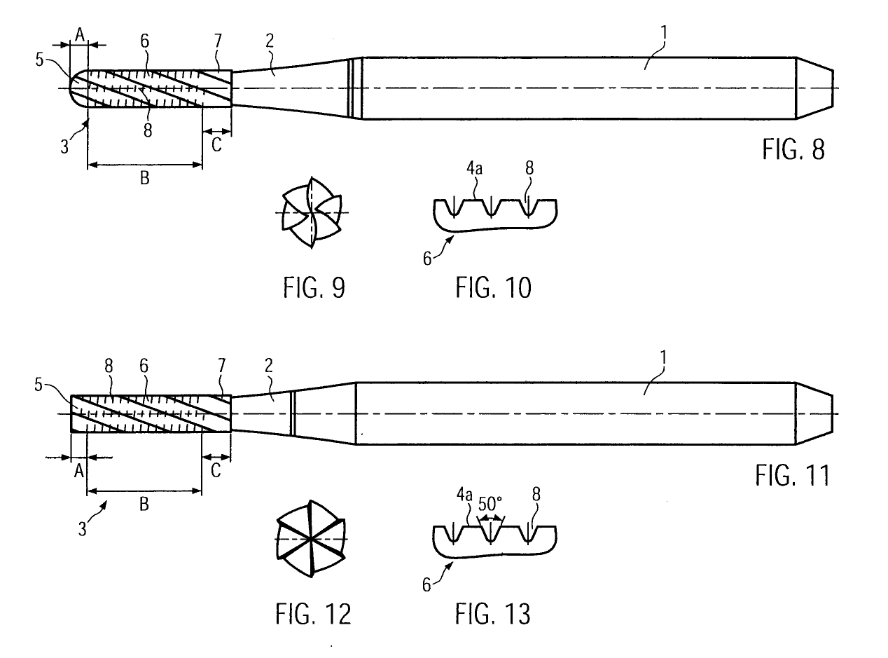

As is discernible from FIGS. 1 and 4, the distal end portion 5 of the head 3 is formed semi-spherical. The cutting edges converge toward the center as it is discernible from the front view of FIG. 9. FIG. 8 shows a technical drawing analogous to the view of FIG. 4.

The distal end portion 5 of the head 3 has cutting edges which are formed continuously and therewith comprise a continuous cutting flange. The same applies for the end portion 7 adjacent to the shaft end 2.

The middle portion 6 of the head 3 is provided with a helically circumferential cross-cut 8 introduced in the form of a circumferential groove and dividing the cutting edge 4 into individual cutting segments or cutting portions 4a, as e.g. shown in FIG. 13. Therewith, a breaking of the chip occurs such that the middle portion 6 serves for a rough processing with high removal performance and increased cutting efficiency.

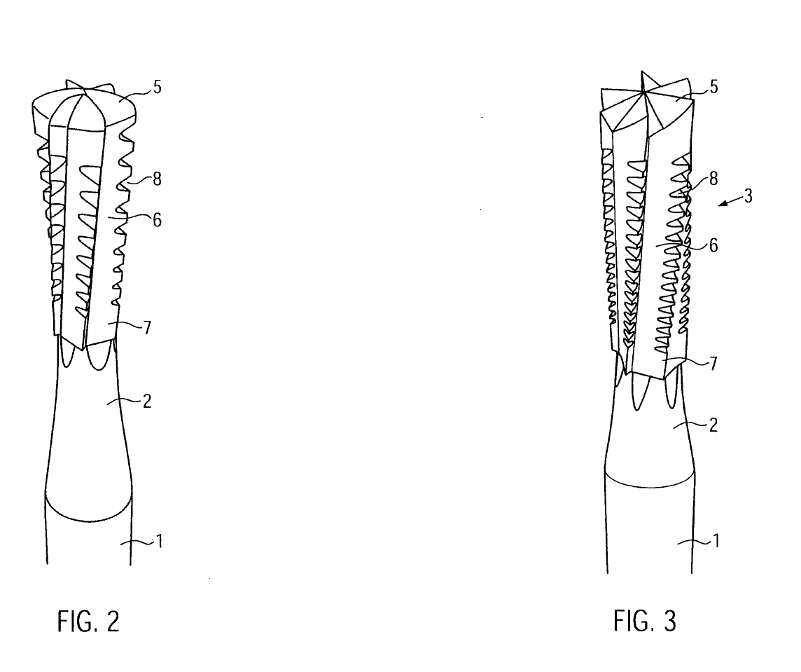

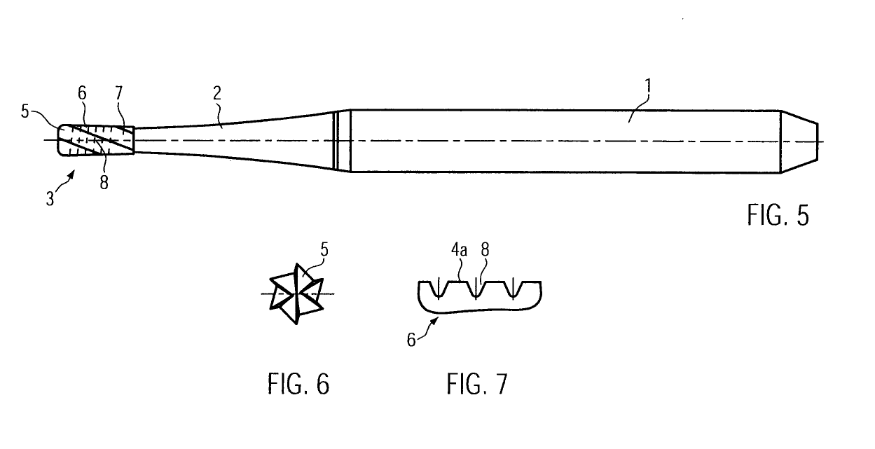

FIGS. 2 and 3 show further preferred embodiments of the inventive dental drill having different head shapes. FIG. 2 shows a slightly conical head being rounded at its distal end portion 5, analogous to the depiction of FIG. 5. FIG. 3 shows a substantially cylindrical head having a flattened end portion analogous to the depiction of FIG. 11. Also in these preferred embodiments, the middle portions 6 are respectively provided with a helical or spiral circumferential cross-cut 8.

Concerning the dimensions of the axial lengths of the portions 5, 6 and 7, reference is made e.g. to FIG. 11. In FIG. 11, the distal end portion 5 is e.g. 0.3 mm long, whereas the middle portion 6 provided with the cross-cut 8 is 3.2 mm long. The axial length C of the end portion 7 is 0.7 mm. As is shown in FIG. 13, the groove of the cross-cut 8 e.g. has an angle of 50°.

FIG. 8 shows e.g. a dimensioning in which the distal end portion is 0.45 mm long, whereas the middle portion 6 has an axial length B of 3.0 mm. The axial length C of the end portion 7 is e.g. 0.75 mm. Also in this embodiment, the groove angle of the cross-cut 8 is 40°.

As results from the front views of FIGS. 6, 9 and 12, different embodiments with or without cross-cuts are possible.

The dental drills of the preferred embodiments are made of hard metal. According to the invention, it is, however, also possible to manufacture same from a ceramic material.

Concerning the dimensions, in particular the axial lengths, there exist numerous possibilities of alterations and variations within the scope of the invention. Same exist also in view of the axial lengths of the cutting segments 4a.

Concerning the cross-cut 8, it is possible to provide a helical circumferential groove, as it is shown in the embodiments of FIGS. 4, 5, 8 and 11. It is also possible to provide a plurality of grooves extending in parallel to each other. Also the pitch of the groove of the cross-cut as well as the twist angle of the cutting edge 4 may be varied according to the invention (e.g. between 0° and 10°).

1. A dental drill comprising a shaft as well as a head being provided with a plurality of cutting edges extending lengthwise of the head, wherein the cutting edges are provided with at least one cross-cut at a middle portion of the head.

2. The dental drill of claim 1, wherein the cross-cut is formed in the shape of a groove and divides the respective cutting edge into individual cutting segments.

3. The dental drill of claim 1, wherein a helical circumferential groove-type cross-cut is provided.

4. The dental drill of claim 1, wherein a plurality of circumferential groove-type cross-cuts are provided.

5. The dental drill of claim 1, wherein the cross-cut interrupts the respective cutting edge at the middle portion of the head.

6. The dental drill of claim 1, wherein the respective cutting edge extends substantially straight-lined.

7. The dental drill of claim 1, wherein the respective cutting edge is divided by the respective cross-cut into individual cutting segments at the middle portion of the head.

8. The dental drill of claim 1, wherein a distal portion of the head, at which the cutting edges are not interrupted by a cross-cut, has an axial length corresponding to 5 to 20% of the complete length of the head.

9. The dental drill of claim 1, wherein a rear portion of the head adjacent to the shaft, where the cutting edges are not interrupted by a cross-cut, has an axial length corresponding to 5 to 20% of the complete length of the head.

10. The dental drill of claim 1, wherein said dental drill is right-hand cutting with respect to a rotation about its axis.

11. The dental drill of claim 1, wherein the cutting edges have a right-handed twist between 0° and 15°.

12. The dental drill of claim 1, wherein the cutting edges have a left-handed twist between 0° and 15°.

13. The dental drill of claim 1, wherein the cross-cut is formed as at least one chamfer interrupting the cutting edges and having a pitch of 0.15 to 0.25 with respect to the longitudinal axis of the dental drill.

14. The dental drill of claim 1, wherein the head is shaped tapered.

15. The dental drill of claim 1, wherein the head is shaped conical.

16. The dental drill of claim 1, wherein the head is shaped spherical.

17. The dental drill of claim 1, wherein the head is pear-shaped.

18. The dental drill of claim 1, wherein the head is formed in the shape of a cylinder.

19. A dental drill having a shaft as well as a head arranged at a distal end of the shaft, the head comprising a plurality of cutting edges, wherein a distal end of the head comprises a plurality of cutting edges extending toward the center of the distal end of the head, wherein a middle portion is formed adjacent to the distal end of the head, wherein, at the middle portion, the cutting edges extending from the distal end are provided with at least one cross-cut and wherein adjacent to the middle portion up to an end of the head adjacent to the shaft, the cutting edges extending from the middle portion of the head are formed without a cross-cut.

20. The dental drill of claim 19, wherein the cross-cut is formed as at least one groove-type chamfer interrupting the cutting edges.

21. A method of manufacturing a dental drill comprising a shaft as well as a head arranged at the distal end of the shaft, wherein a blank shape of the shaft and the head is produced in a first processing step, wherein the cutting edges at the head are produced by means of a grinding process in a subsequent processing step, and wherein a helical circumferential groove-type chamfer for dividing the cutting edges of the middle portion of the head into single cutting segments is introduced in a subsequent processing step.
